(19) United States
(12) Patent Application Publication
(10) Pub. No.: US 2026/0145594 A1
(43) Pub. Date: May 28, 2026

(54) CONTROL SYSTEM FOR A VEHICLE SEAT AND VEHICLE SEAT COMPRISING THE CONTROL SYSTEM

(71) Applicant: FAURECIA Sièges d'Automobile, NANTERRE (FR)

(72) Inventors: Julien TANGUY, Le Vey (FR); Denis RICHARD, SAINT MARTIN DE FONTENAY (FR)

(21) Appl. No.: 19/181,535

(22) Filed: Apr. 17, 2025

(30) Foreign Application Priority Data
Apr. 19, 2024 (FR) 2404101

(51) Int. Cl. B60N 2/16

(52) U.S. Cl. CPC B60N 2/169; B60N 2/1685

(57) ABSTRACT

A control system for a motor vehicle seat comprising a control device comprising a control shaft and a support plate comprising at least one fastening hole, wherein the control shaft is configured to rotate about a control axis relative to the support plate, at least one fastening element, wherein the fastening element comprises a fastening head, an intermediate portion and a rod portion, the fastening head comprises a rim, the intermediate portion has a non-circular section and the fastening hole has a shape complementary to the intermediate portion, a flange comprising a holding hole, the rod portion extending through the holding hole, and a locking element cooperating with the rod portion.

### PRIORITY CLAIM

This application claims priority to French Patent Application No. FR2404101, filed Apr. 19, 2024, which is expressly incorporated by reference herein.

### BACKGROUND

The present disclosure relates to X a control system for a vehicle seat and a vehicle seat comprising the control system. The control system can, in particular, form a manual or electric height adjustment system. The vehicle seat is, in particular, a motor vehicle seat.

### SUMMARY

According to the present disclosure, a control system for a vehicle seat comprises
a control device comprising a control shaft and a support plate, wherein the support plate has a first fastening face and a second fastening face, the support plate comprises at least one fastening hole extending between the first fastening face and the second fastening face, the control shaft is configured to rotate about a control axis relative to the support plate,
at least one fastening element, the fastening element has a fastening axis parallel to the control axis, the fastening element comprises a fastening head and a rod portion,
a flange having a first holding face and a second holding face, the first holding face extending facing the second fastening face, wherein the flange comprises a holding hole, wherein the holding hole extends between the first holding face and the second holding face, the rod portion extending through the holding hole,
a locking element cooperating with the rod portion to hold back the control device against translation along the fastening axis, relative to the flange.

In illustrative embodiments, the fastening head comprises a shoulder and a rim, the shoulder has a contact face extending facing the second fastening face (along the fastening axis), the rim has a retaining face extending facing the first fastening face (along the fastening axis), so that the fastening element is prevented from translating along the fastening axis relative to the support plate, the support plate being retained between the rim and the shoulder.

Thus, the fastening element is fastened to the support plate before the support plate is fastened to the flange. Furthermore, placing a tool to stop the fastening element from rotating about the fastening axis can be avoided. Under these conditions, the fastening head can be arranged closer to the control device, which reduces the bulkiness of the control system. This makes it easier to fasten the control device to the flange.

According to another feature, the rim is preferably formed by a plurality of disjointed rim portions.

Thus, the ratio between the effort needed to produce the rim and the resistance of the rim to deformation is increased. In other words, for a given mechanical resistance of the material and a given machine power to produce the rim, the resistance of the rim to mechanical stresses can be improved.

According to an additional or alternative feature, each rim portion preferably has, perpendicular to the fastening axis, a moon crescent shape.

A good ratio between the effort to produce the rim and the resistance of the rim is thus achieved.

According to another feature, the rim is preferably produced by stamping.

According to another feature, the fastening head preferably comprises an intermediate portion, perpendicular to the fastening axis, the intermediate portion has a non-circular section, the fastening hole has a shape complementary to the intermediate portion cooperating with the intermediate portion to hold the fastening element in rotation about the fastening axis relative to the support plate.

Thus, the rotation of the fastening element about the fastening axis is strongly prevented, whereby placing a tool to stop the fastening element from rotating about the fastening axis is avoided.

According to an additional feature, the intermediate portion preferably has, perpendicular to the fastening axis, a plurality of vertices, and the fastening hole comprises a first stop portion and a second stop portion on either side of each vertex forming a rotational stop to stop the intermediate portion from rotating about the fastening axis.

According to an additional feature, the intermediate portion preferably has, perpendicular to the fastening axis, an elongated shape extending in an elongation direction between a first vertex and a second vertex.

Thus, a good compromise is found between the resistance and the cost of the control system.

According to another feature, the fastening element preferably comprises a conical portion coming into contact with the holding hole.

This reduces the clearance between the support plate and the flange. Given the tightening force, the movements between the support plate and the flange are reduced. However, particularly in the case where the control device operates by wedging, vibrations are likely to cause movements between the support plate and the flange causing unexpected movements in the control device which can be reduced thanks to the feature mentioned above.

According to a complementary feature, the holding hole is preferably deformed by the contact with the conical portion.

Thus, it is not necessary to have very small dimensional tolerances to avoid the conical portion substantially reducing the pressure exerted along the fastening axis.

According to a combined or alternative feature, the locking element is a nut.

In the case where this feature and the previous one are combined, the deformation of the holding hole can be achieved by tightening the nut, in particular between the support plate and the flange.

To this end, the fastening element preferably has a hardness greater than the flange hardness.

According to another feature, the conical portion is preferably in contact with the holding hole in a plurality of separate contact zones.

The retaining hole resistance to deformation is thus very significantly reduced compared to the case where the contact between the fastening element and the holding hole is continuous, because a closed (continuous) annular bead would then form.

Preferably, the conical portion is in contact with the holding hole in two diametrically opposed contact zones, opposed to one another perpendicular to the fastening axis.

According to a combined or alternative feature, the flange preferably comprises a bore through which the control shaft extends, and the support plate comprises an annular portion, the annular portion having an outer surface cooperating with the bore of the flange.

Thus, the fastening axis can only move in rotation relative to the control axis about the control axis and a single fastening element comprising a conical portion is sufficient to oppose this movement.

According to another feature, preferably the control system further comprises a guiding plate, the guiding plate has a guiding hole and a bearing hole, the fastening element extends into the guiding hole and the guiding plate is held along the fastening axis between the flange and the nut, the bearing hole forms a bearing for the control shaft.

Thus, the control system does not need any additional operation to guide the control shaft.

The present disclosure further relates to a vehicle seat comprising the control system.

According to another feature, the one vehicle seat further comprises a pinion integral with the control shaft and the seat further comprises a connecting rod and a toothed portion, wherein the connecting rod is rotatably articulated relative to the flange about an articulation axis and the toothed portion is integral with the connecting rod and cooperates with the pinion.

According to an additional feature, the vehicle seat preferably comprises a seat base frame comprising the flange and the control device forms a height adjustment device allowing the height of the seat base frame to be adjusted.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 schematically represents a vehicle seat comprising a seat base, the seat base comprising a frame and being equipped with a control system according to a first embodiment;

FIG. 2 schematically represents the vehicle seat whose seat base frame is equipped with a control system according to a second embodiment;

FIG. 3 is a perspective view of the seat base frame equipped with the control system according to the first embodiment;

FIG. 4 represents the control system according to the first embodiment in exploded perspective;

FIG. 5 represents the control system according to arrow V in FIG. 3;

FIG. 6 represents the control system in sectional view along the line marked VI-VI in FIG. 5;

FIG. 7 represents the control system in sectional view along the line marked VII-VII in FIG. 6;

FIG. 8 represents the control system in sectional view along the line marked VIII-VIII in FIG. 6; and

FIG. 9 illustrates an operation for implementing the control system.

### DETAILED DESCRIPTION

The drawings and description below contain, for the most part, elements of a definite nature. They may therefore not only serve to better understand the present disclosure, but also contribute to its definition, where appropriate.

Taking this into account, the present disclosure relates to a seat 100 comprising a seat base 102 and a backrest 104. The seat 100 is arranged on a vehicle floor 80.

As illustrated in particular in FIG. 2, the seat base 102 comprises a control system 1 for adjusting the height of the seat base 102 relative to the vehicle floor 80.

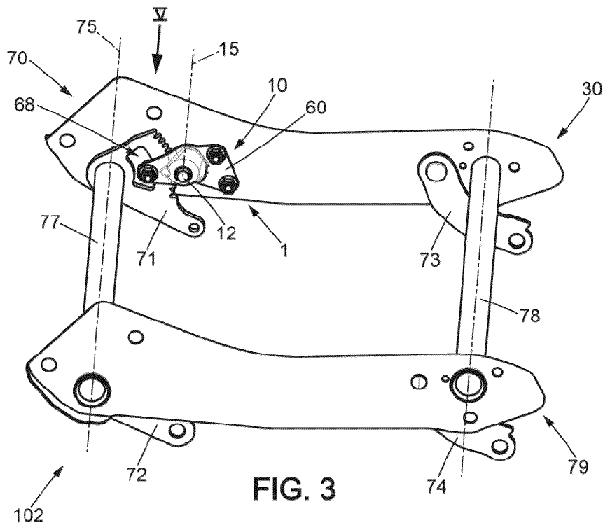

As illustrated in particular in FIG. 3, the seat base 102 comprises a seat base frame 70 and a control system 1. The seat base frame 70 comprises a flange 30, connected to an opposite flange 79 by a front crosspiece 77 and a rear crosspiece 78. The front crosspiece 77 and the rear crosspiece 78 extend in an axial direction Z. The flange 30 and the opposite flange 79 are formed by shaped plates extending substantially perpendicular to the axial direction Z. The seat 100 further comprises a connecting rod 71 and three other connecting rods 72, 73, 74 supporting the seat base frame 70. A toothed portion 76 is connected to the connecting rod 71. The connecting rods 71, 72, 73, 74 each have an upper end articulated in rotation relative to the seat base frame 70 about a respective upper axis extending in the axial direction Z and a lower end articulated in rotation relative to the vehicle floor 80 about a respective lower axis extending in the axial direction Z. In the first embodiment, the toothed portion 76 has a circular shape centered on the upper articulation axis of the connecting rod 71. Alternatively, the toothed portion 76 could be rectilinear and form a rack. In the illustrated embodiments, the seat 100 further comprises slides 90 arranged between the vehicle floor 80 and the connecting rods 71, 72, 73, 74.

The control system 1 comprises a control device 10, the flange 30, at least one fastening element 50 and a locking element. In the illustrated embodiments, the locking element is a nut 40. Alternatively, the locking element could be a pin or a similar device. Further, in the illustrated embodiments, there are three fastening elements 50 and three nuts 40. The control device 10 comprises a control shaft 12, a pinion 14, a drive device 18 and a support plate 20. The control shaft 12 can be rotatably driven about the control axis 15 relative to the support plate 20 by the drive device 18 so as to act upon the connecting rod 71. The control axis 15 extends in the axial direction Z.

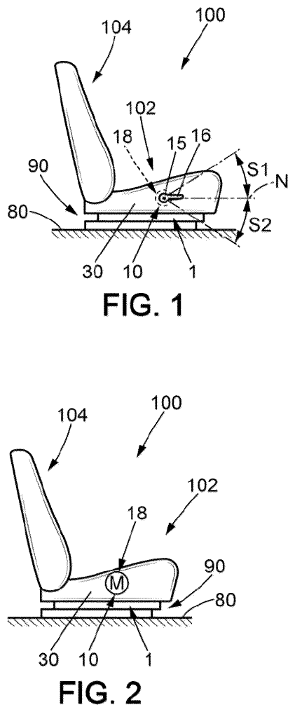

In the embodiment illustrated in FIG. 1, the drive device 18 is of the manual type and comprises a control handle 16 operable by a user. The drive device 18 comprises a first stage immobilizing the control shaft 12 in rotation about the control axis 15 relative to the support plate 20 and a second, optional, stage actuated by the control handle 16. The control handle 16 is elastically biased by the second stage to a neutral position N relative to the support plate 20. When the control handle 16 is moved away from the neutral position N by rotation about control axis 15 in a first direction S1 relative to the support plate 20, the control handle 16 drives the control shaft 12 in rotation about the control axis 15 in the first direction S1. When the control handle 16 is moved away from the neutral position N by rotation about control axis 15 in a second direction S2, opposite the first direction S1, relative to the support plate 20, the control handle 16 drives the control shaft 12 in rotation about control axis 15 in the second direction S2 relative to the support plate 20. When the control handle 16 returns to the neutral position N, the control shaft 12 is held immobilized in rotation relative to the support plate 20 by the first stage of the drive device 18.

For readability, the control handle 16 is only illustrated in FIG. 1.

FIG. 2 illustrates an alternative drive device 18 comprising a geared motor M. The geared motor M comprises an electric motor and an irreversible reducer, such as an endless screw-wheel system, connecting the electric motor to the control shaft 12. The drive device 18 further comprises a first control and a second control (not shown), of the switch type, or of a similar control type, controlling the electric motor, so as to rotate the control shaft 12 in the first direction S1 and in the second direction S2.

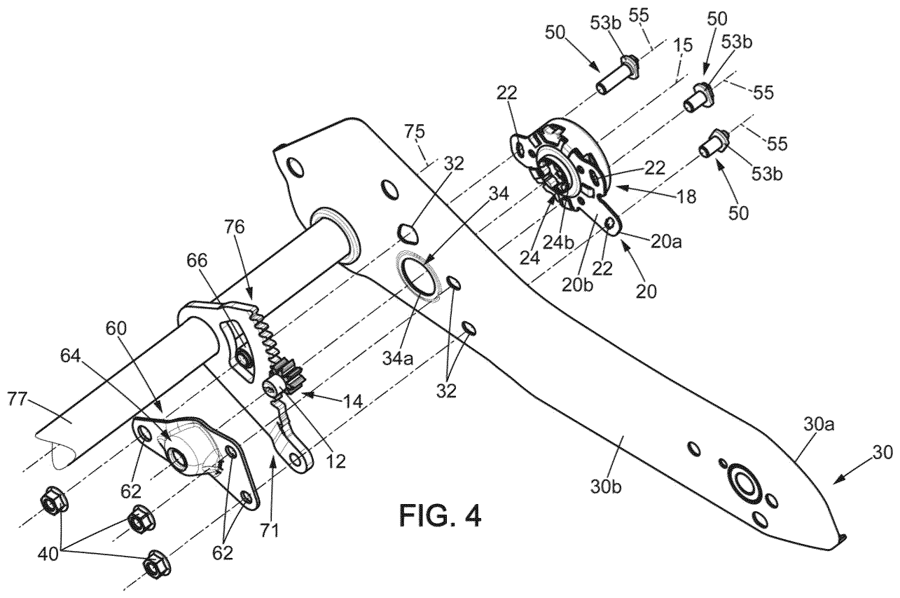

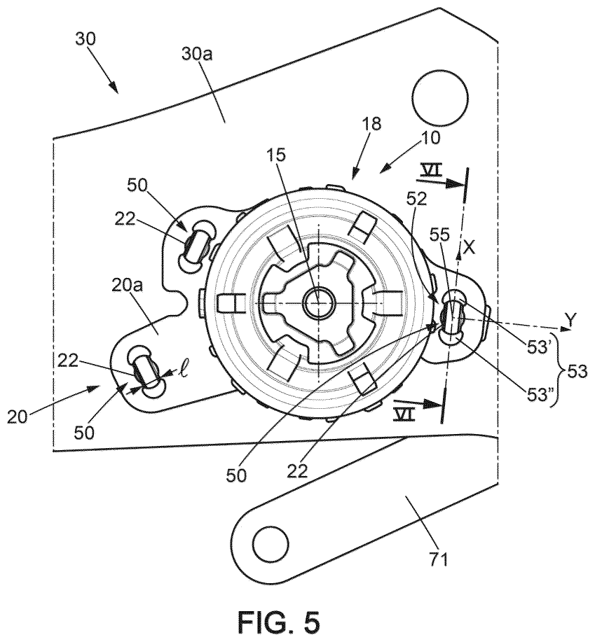

Hereinafter, the disclosure will be made in relation in particular to FIGS. 4 and 5 illustrating the drive device 18 of the first embodiment. However, the remainder of the disclosure would apply similarly in relation to the drive device according to the second embodiment.

The support plate 20 supports the drive device 18. The pinion 14 is rigidly fastened to the control shaft 12 and cooperates with the toothed portion 76. The rotation of the control shaft 12 therefore drives the connecting rod 71 into rotation. The connecting rods 71, 72, 73, 74, the flange 30, the opposite flange 79 and the slides 90 form two deformable parallelograms transforming the rotation of the connecting rod 71 into a height displacement of the seat base 102.

The support plate 20 has a first fastening face 20a and a second fastening face 20b, opposite the first fastening face 20a. The drive device 18 is held on the first fastening face 20a and rigidly fastened to the support plate 20. The support plate 20 comprises three fastening holes 22 passing through the support plate 20 from the first fastening face 20a to the second fastening face 20b. The support plate 20 comprises an annular portion 24 coaxial with the control axis 15. The annular portion 24 has an outer surface 24b.

The flange 30 has a first holding face 30a and a second holding face 30b, opposite the first holding face 30a. The first holding face 30a extends facing the second fastening face 20b. The flange 30 further comprises a bore 34 having an inner surface 34a. The annular portion 24 of the support plate 20 extends into the bore 34 of the flange 30 and the outer surface 24b of the annular portion 24 cooperates with the inner surface 34a of the bore 34, so that the bore 34 of the flange 30 is centered relative to the control axis 15. The flange 30 further comprises three holding holes 32 extending through the flange 30 between the first holding face 30a and the second holding face 30b.

The fastening elements 50 each extend along a fastening axis 55 parallel to the axial direction Z between a first end 50a and a second end 50b. The fastening elements 50 comprise successively along the axial direction Z, from the first end 50a towards the second end 50b, a fastening head 52, an intermediate portion 54, a shoulder 56, a conical portion 57 and a rod portion 58.

The fastening head 52 comprises successively in the axial direction Z, from the first end 50a towards the second end 50b, an end portion 51, a rim 53 and an intermediate portion 54.

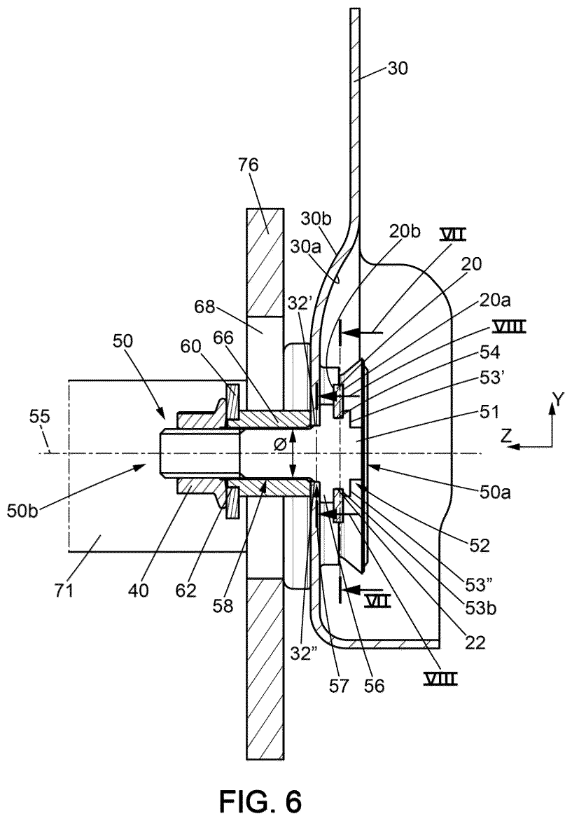

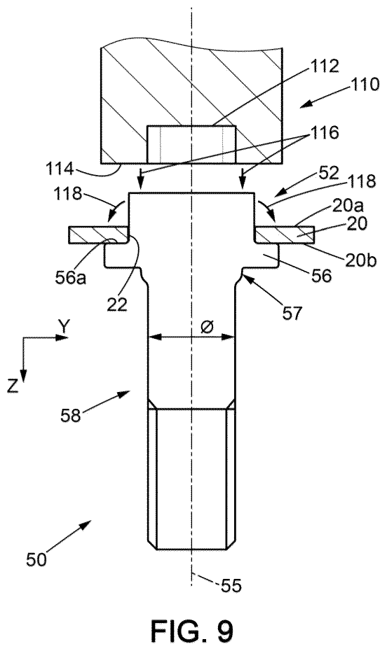

As illustrated in particular in FIGS. 6 and 9, the rod portion 58 has a rod diameter Φ and is threaded at least in part in order to cooperate with the nut 40.

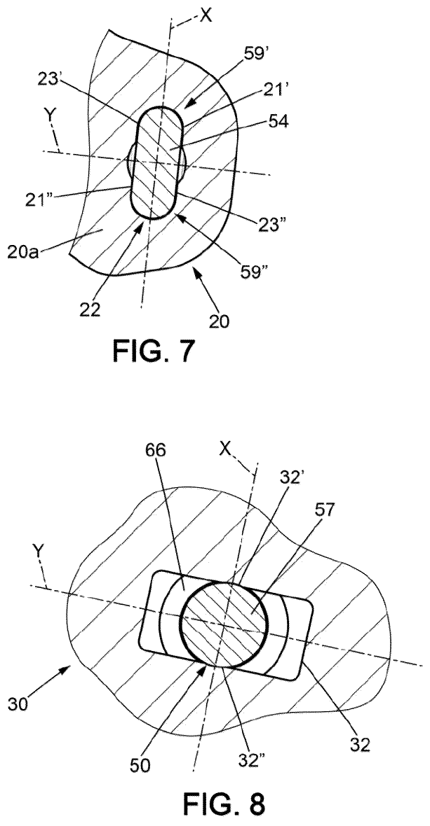

Perpendicular to the fastening axis 55, the intermediate portion 54 of each fastening element 50 has a non-circular section and each fastening hole 22 of the support plate 20 has a complementary section blocking the fastening element 50 in rotation about the fastening axis 55 relative to the support plate 20. More specifically, as illustrated in particular in FIG. 7, the intermediate portion 54 has a plurality of vertices 59′, 59″ and the fastening head comprises a first stop portion 21′, 21″ and a second stop portion 23′, 23″ at each vertex 59′, 59″. The first stop portions 21′, 21″ prevent the fastening element 50 from rotating relative to the support plate 20 about fastening axis 55 by forming an abutment in one direction and the second stop portions 23′, 23″ prevent the fastening element 50 from rotating relative to the support plate 20 about fastening axis 55 by forming an abutment in an opposite direction.

In the illustrated embodiment, each fastening element 50 has an elongated shape extending in an elongation direction X between a first vertex 59′and a second vertex 59″.

As illustrated in particular in FIG. 6, the shoulder 56 has a flat contact face 56a, extending perpendicular to the fastening axis 55 and facing the second fastening face 20b. More specifically, in the illustrated embodiment, the contact face 56a is in contact with the second fastening face 20b.

As illustrated in particular in FIGS. 5 and 6, the rim 53 has a retaining face 53b facing the first fastening face 20a. More specifically, in the illustrated embodiment, the retaining face 53b is in contact with the first fastening face 20a.

As particularly apparent in FIG. 5, the rim 53 comprises a plurality of separate rim portions. In the embodiment, the rim 53 comprises two rim portions 53′, 53″ diametrically opposed to one another in the elongation direction X. Each rim portion 53′, 53″ has, perpendicular to the fastening axis 55, a moon crescent shape.

The end portion 51 projects from the rim 53 in the axial direction Z. The end portion 51 has, perpendicular to the axial direction Z, an elongated shape in the elongation direction X. The end portion 51 has, in the elongation direction X, a length greater than the rod diameter Φ of the rod portion 58. The fastening head 52 has a width l in a transverse direction Y perpendicular to the elongation direction X and to the axial direction Z. The width l of the fastening head 52 is constant in the axial direction Z and is smaller than the rod diameter Φ of the rod portion 58.

FIG. 9 illustrates the production of the rim 53 by stamping. The fastening head 52 initially has, perpendicular to the axial direction Z, a constant section in the axial direction Z. The fastening head 52 of each fastening element 50 is inserted into the corresponding fastening hole 22 of the support plate 20, until the contact face 56a of the shoulder 56 is brought into contact with the second fastening face 20b of the support plate 20. Then, a punch 110 having a cavity 112 and a stamping face 114 is applied against the first end 50a of the fastening element 50, as illustrated by the first arrows 116. The punch movement is continued and the punch 110 deforms the fastening head 52 with the stamping face 114 so as to create the rim portions 53′, 53″ coming to bear against the first fastening face 20a of the support plate, as illustrated by the second arrows 118, the end portion 51 being housed in the cavity 112 is not deformed.

Thus, the fastening element 50 is retained against translation in the axial direction Z relative to the support plate 20 by the rim portions 53′, 53″ and in the opposite direction by the shoulder 56. More generally, the support plate 20 being pinched between the rim 53 and the shoulder 56, the retaining face 53b being applied against the first fastening face 20a and the contact face 56a being applied against the second fastening face 20b, the rim 53 and the shoulder 56 only allow each fastening element 50 to pivot about the fastening axis 55 relative to the support plate 20. However, since the rotational movement of each fastening element 50 relative to the support plate 20 about the fastening axis 55 is prevented by the cooperation between the intermediate portion 54 and the fastening hole 22, each fastening element 50 is rigidly fastened to the support plate 20.

As illustrated in particular in FIGS. 6 and 8, the conical portion 57 of one of the fastening elements 55 comes into contact with the holding hole 32. It is not necessary for more than one fastening element 50 to have a conical portion 57 or at least for the conical portion 57 to come into contact with the fastening hole 22, since the support plate 20 is guided relative to the flange 30 by the cooperation between the annular portion 24 and the bore 34.

As illustrated in FIG. 8, perpendicular to the axial direction Z, the holding hole 32 does not have a circular section. Consequently, the conical portion 57 is in contact with the holding hole 32 in a plurality of separate contact zones 32′, 32″. In the illustrated embodiment, perpendicular to the axial direction Z, the holding hole 32 having a rectangular section, the conical portion 57 is in contact with the holding hole 32 in two separate contact zones 32′, 32″ that are diametrically opposed to one another in the elongation direction X.

The fastening element 50 having a much greater hardness than the hardness of the flange 30, the conical portion 57 is not deformed by the contact with the holding hole 32, but on the contrary the holding hole 32 is deformed by the conical portion 57 in the contact zones 32′, 32″, upon tightening the nut 40.

As illustrated in particular in FIGS. 4 and 6, the guiding plate 60 has guiding holes 62 and a bearing hole 64. The guiding holes 62 are passed through by the rod portion 58 of each fastening element 50. The nuts 40 press the guiding plate 60 in the axial direction Z.

As illustrated in particular in FIGS. 4 and 6, one of the fastening elements 50 passes through an opening 68 in the toothed portion 76. The rod portion 58 extends through a spacer 66 and the spacer 66 is interposed between the guiding plate 60 and the flange 30 in the axial direction Z. The other two fastening elements 50 hold the guiding plate 60 directly against the flange 30 (there is no spacer between the guiding plate 60 and the flange 30) by tightening the nuts 40.

The guiding plate 60 further comprises a bearing hole 64 forming a bearing for the control shaft 12. The pinion 14 is thus arranged in a housing of the guiding plate 60 extending between the guiding plate 60 and the flange 30.

The present disclosure is not limited to the embodiments described above and provided solely by way of example. It encompasses various modifications, alternative forms and other variants that may be considered by the person skilled in the art within the framework of this disclosure and in particular all combinations of the different operating modes described above, which may be taken separately or in combination.

A comparative control system for a vehicle seat comprises:
a control device comprising a control shaft and a support plate, wherein the support plate has a first fastening face and a second fastening face, the support plate comprises at least one fastening hole extending between the first fastening face and the second fastening face, the control shaft is configured to rotate about a control axis relative to the support plate,
at least one fastening element, the fastening element has a fastening axis parallel to the control axis, the fastening element comprises a fastening head and a rod portion,
a flange having a first holding face and a second holding face, the first holding face extending facing the second fastening face, wherein the flange comprises a holding hole, wherein the holding hole extends between the first holding face and the second holding face, the rod portion extending through the holding hole,
a locking element cooperating with the rod portion to hold back the control device against translation along the fastening axis, relative to the flange.

The present disclosure aims to improve fastening the control device onto the flange, in particular in order to facilitate its production, improve its robustness or improve the system compactness.

To overcome the aforementioned problems, in accordance with the present disclosure, the fastening head comprises a shoulder and a rim, the shoulder has a contact face extending facing the second fastening face (along the fastening axis), the rim has a retaining face extending facing the first fastening face (along the fastening axis), so that the fastening element is prevented from translating along the fastening axis relative to the support plate, the support plate being retained between the rim and the shoulder.

Thus, the fastening element is fastened to the support plate before the support plate is fastened to the flange. Furthermore, placing a tool to stop the fastening element from rotating about the fastening axis can be avoided. Under these conditions, the fastening head can be arranged closer to the control device, which reduces the bulkiness of the control system. This makes it easier to fasten the control device to the flange.

According to another feature, the rim is preferably formed by a plurality of disjointed rim portions.

Thus, the ratio between the effort needed to produce the rim and the resistance of the rim to deformation is increased. In other words, for a given mechanical resistance of the material and a given machine power to produce the rim, the resistance of the rim to mechanical stresses can be improved.

According to an additional or alternative feature, each rim portion preferably has, perpendicular to the fastening axis, a moon crescent shape.

A good ratio between the effort to produce the rim and the resistance of the rim is thus achieved.

According to another feature, the rim is preferably produced by stamping.

According to another feature, the fastening head preferably comprises an intermediate portion, perpendicular to the fastening axis, the intermediate portion has a non-circular section, the fastening hole has a shape complementary to the intermediate portion cooperating with the intermediate portion to hold the fastening element in rotation about the fastening axis relative to the support plate.

Thus, the rotation of the fastening element about the fastening axis is strongly prevented, whereby placing a tool to stop the fastening element from rotating about the fastening axis is avoided.

According to an additional feature, the intermediate portion preferably has, perpendicular to the fastening axis, a plurality of vertices, and the fastening hole comprises a first stop portion and a second stop portion on either side of each vertex forming a rotational stop to stop the intermediate portion from rotating about the fastening axis.

According to an additional feature, the intermediate portion preferably has, perpendicular to the fastening axis, an elongated shape extending in an elongation direction between a first vertex and a second vertex.

Thus, a good compromise is found between the resistance and the cost of the control system.

According to another feature, the fastening element preferably comprises a conical portion coming into contact with the holding hole.

This reduces the clearance between the support plate and the flange. Given the tightening force, the movements between the support plate and the flange are reduced. However, particularly in the case where the control device operates by wedging, vibrations are likely to cause movements between the support plate and the flange causing unexpected movements in the control device which can be reduced thanks to the feature mentioned above.

According to a complementary feature, the holding hole is preferably deformed by the contact with the conical portion.

Thus, it is not necessary to have very small dimensional tolerances to avoid the conical portion substantially reducing the pressure exerted along the fastening axis.

According to a combined or alternative feature, the locking element is a nut.

In the case where this feature and the previous one are combined, the deformation of the holding hole can be achieved by tightening the nut, in particular between the support plate and the flange.

To this end, the fastening element preferably has a hardness greater than the flange hardness.

According to another feature, the conical portion is preferably in contact with the holding hole in a plurality of separate contact zones.

The retaining hole resistance to deformation is thus very significantly reduced compared to the case where the contact between the fastening element and the holding hole is continuous, because a closed (continuous) annular bead would then form.

Preferably, the conical portion is in contact with the holding hole in two diametrically opposed contact zones, opposed to one another perpendicular to the fastening axis.

According to a combined or alternative feature, the flange preferably comprises a bore through which the control shaft extends, and the support plate comprises an annular portion, the annular portion having an outer surface cooperating with the bore of the flange.

Thus, the fastening axis can only move in rotation relative to the control axis about the control axis and a single fastening element comprising a conical portion is sufficient to oppose this movement.

According to another feature, preferably the control system further comprises a guiding plate, the guiding plate has a guiding hole and a bearing hole, the fastening element extends into the guiding hole and the guiding plate is held along the fastening axis between the flange and the nut, the bearing hole forms a bearing for the control shaft.

Thus, the control system does not need any additional operation to guide the control shaft.

The present disclosure further relates to a vehicle seat comprising the control system.

According to another feature, the one vehicle seat further comprises a pinion integral with the control shaft and the seat further comprises a connecting rod and a toothed portion, wherein the connecting rod is rotatably articulated relative to the flange about an articulation axis and the toothed portion is integral with the connecting rod and cooperates with the pinion.

According to an additional feature, the vehicle seat preferably comprises a seat base frame comprising the flange and the control device forms a height adjustment device allowing the height of the seat base frame to be adjusted.

A Control system (1) for a motor vehicle seat (100) comprising:
a control device (10) comprising a control shaft (12) and a support plate (20) comprising at least one fastening hole (22), wherein the control shaft (12) is configured to rotate about a control axis (15) relative to the support plate (20),
at least one fastening element (50), wherein the fastening element (50) comprises a fastening head (52), an intermediate portion (54) and a rod portion (58), the fastening head (52) comprises a rim (53), the intermediate portion (54) has a non-circular section and the fastening hole (22) has a shape complementary to the intermediate portion (54),
a flange (30) comprising a holding hole (32), the rod portion (58) extending through the holding hole (32), and
a locking element (40) cooperating with the rod portion (58).

1. A control system for a vehicle seat comprising:
a control device comprising a control shaft and a support plate, wherein the support plate has a first fastening face and a second fastening face, the support plate comprises at least one fastening hole extending between the first fastening face and the second fastening face, the control shaft is configured to rotate about a control axis relative to the support plate,
at least one fastening element, wherein the fastening element has a fastening axis parallel to the control axis, the fastening element comprises a fastening head and a rod portion,
a flange having a first holding face and a second holding face, the first holding face extending facing the second fastening face, the flange comprises a holding hole, the holding hole extends between the first holding face and the second holding face, the rod portion extending through the holding hole,
a locking element cooperating with the rod portion to hold back the control device against translation along the fastening axis, relative to the flange.
wherein that the fastening head comprises:
a shoulder, the shoulder has a contact face extending facing the second fastening face, and
a rim, wherein the rim has a retaining face extending facing the first fastening face, so that the fastening element is prevented from translating along the fastening axis relative to the support plate which is retained between the rim and the shoulder.

2. The control system of claim 1, wherein the rim is formed by a plurality of separate rim portions.

3. The control system of claim 2, wherein each rim portion has, perpendicular to the fastening axis, a moon crescent shape.

4. The control system of claim 1, wherein the rim is produced by stamping.

5. The control system of claim 1, wherein the fastening head comprises an intermediate portion, perpendicular to the fastening axis, the intermediate portion has a non-circular section, the fastening hole has a shape complementary to the intermediate portion cooperating with the intermediate portion to hold the fastening element in rotation about the fastening axis relative to the support plate.

6. The control system of claim 1, wherein the fastening element comprises a conical portion coming into contact with the holding hole.

7. The control system of claim 6, wherein the holding hole is deformed by the contact with the conical portion.

8. The control system of claim 6, wherein the conical portion is in contact with the holding hole in a plurality of separate contact zones.

9. A vehicle seat comprising the control system according claim 1.

10. The vehicle seat according to claim 9, wherein the control system further comprises a pinion integral with the control shaft and the seat further comprises:
a connecting rod articulated in rotation relative to the flange about an articulation axis, and
a toothed portion integral with the connecting rod and cooperating with the pinion.
